(19) United States
(12) Patent Application Publication
(10) Pub. No.: US 2026/0119500 A1
(43) Pub. Date: Apr. 30, 2026

(54) DATA QUERY METHOD, COMPUTER DEVICE, AND STORAGE MEDIUM

(71) Applicant: BEIJING DIPEAK TECHNOLOGY CO., LTD, Beijing (CN)

(72) Inventors: Changhua HE, Beijing (CN); Xirong JIANG, Beijing (CN); Yu HU, Beijing (CN); Suo TONG, Beijing (CN)

(73) Assignee: BEIJING DIPEAK TECHNOLOGY CO., LTD, Beijing (CN)

(21) Appl. No.: 19/149,840

(22) PCT Filed: Jul. 4, 2024
(86) PCT No.: PCT/CN2024/103503

§ 371 Date: Jul. 21, 2025

(30) Foreign Application Priority Data
Jul. 14, 2023 (CN) 202310871324.1

(51) Int. Cl. G06F 16/2455

(52) U.S. Cl. CPC G06F 16/2455

(57) ABSTRACT

A data query method, a computer device, and a storage medium are provided. Virtual data tables corresponding to a physical data table are generated by means of attribute information of the physical data table, then a plurality of target virtual data tables among the virtual data tables are associated to obtain a wide virtual data table, and data querying is performed by using the wide virtual data table.

### CROSS REFERENCE TO THE RELATED APPLICATIONS

This application is the national phase entry of International Application No. PCT/CN2024/103503, filed on Jul. 4, 2024, which is based upon and claims priority to Chinese Patent Application No. 202310871324.1, filed on Jul. 14, 2023, the entire contents of which are incorporated herein by reference.

### TECHNICAL FIELD

The present disclosure relates to the field of computer technologies, and in particular, to a data query method, a computer device, and a storage medium.

### BACKGROUND

In a database, a large amount of data is stored in a form of physical data tables. The physical data tables usually come from different data sources, with significantly different data structures, different types of stored data, and a large amount of data, resulting in low efficiency in directly querying data from the physical tables. If various physical data tables are directly integrated into one physical data wide table, a large amount of storage space is required. Since the physical data wide table contains a large amount of data, updating the model of the physical data wide table becomes difficult, and it is also difficult to add a new field or set a new definition for the wide table.

### SUMMARY

The embodiment of the present disclosure at least provides a data query method, a computer device and a storage medium.

In a first aspect, a data query method is provided in an embodiment of the present disclosure, including:
acquiring, attribute information of a plurality of physical data tables;
generating, for any one of the physical data tables, based on the attribute information, a virtual data table corresponding to the physical data table; where the virtual data table and the physical data table have a same data structure, and each data in the virtual data table respectively refers to corresponding data in the physical data table;
associating, a plurality of target virtual data tables in the virtual data tables, to generate a virtual data wide table corresponding to the target virtual data tables, where each data in the virtual data wide table respectively refers to corresponding data in the target virtual data tables; and determining, in response to a data query instruction for the virtual data wide table, target data corresponding to the data query instruction based on the virtual data wide table.

In an alternative implementation, the associating, the plurality of target virtual data tables in the virtual data tables, to generate the virtual data wide table corresponding to the target virtual data tables includes:
selecting, a reference data table from the target virtual data tables;
selecting, an association data table from remaining target virtual data tables;
associating, the reference data table with the association data table, to obtain a new reference data table; and
repeating, steps of selecting the association data table and associating the reference data table with the association data table, until the number of the remaining target virtual data tables is zero.

In an alternative implementation, the associating, the reference data table with the association data table, to obtain the new reference data table includes:
selecting, based on attribute information of the reference data table and the association data table, a target association mode from a plurality of association modes; and
associating, the reference data table with the association data table by using the target association mode, to obtain the new reference data table.

In an alternative implementation, the target virtual data tables are screened out from the virtual data tables by:
acquiring, at least one predetermined query statement of a target query service; and
determining, based on the predetermined query statement, the target virtual data table matching the predetermined query statement.

In an alternative implementation, the determining, in response to the data query instruction for the virtual data wide table, target data corresponding to the data query instruction based on the virtual data wide table includes:
determining, in response to the data query instruction for the virtual data wide table, a data query path corresponding to the data query instruction, based on a data reference relationship indicated in the virtual data wide table;
searching for target query data matching any one of query nodes in the data query path from currently stored intermediate query data; where the query nodes indicate data query logic for determining the intermediate query data; and
in response to any one of the target query data being found, performing, starting from the query node corresponding to the target query data, data query according to the data query path based on the target query data, to obtain the target data corresponding to the data query instruction.

In an alternative implementation, after searching for the target query data corresponding to any one of the query nodes in the data query path, the method further includes:
in response to none of the target query data being found, performing, starting from an initial query node of the data query path, the data query according to the data query path, to obtain the target data corresponding to the data query instruction.

In an alternative implementation, the method further includes:
in a process of performing the data query according to the data query path, for each of the query nodes, determining, based on at least one of a predicted query frequency, a historical query frequency and a calculation complexity corresponding to the query node, an importance evaluation value of the query node; and
storing, in response to the importance evaluation value being higher than or equal to a predetermined evaluation value, the intermediate query data corresponding to the query node.

According to a second aspect, a computer device is further provided in an alternative implementation of the present disclosure, including: one or more processors and one or more memories, where the memories store machine-readable instructions executable by the processors, the processors are configured to execute the machine-readable instructions stored in the memories, and when the machine-readable instructions are executed by the processors, steps in the first aspect or any possible implementation of the first aspect are performed.

According to a third aspect, a computer-readable storage medium is further provided in an alternative implementation of the present disclosure, the computer-readable storage medium stores computer programs, and when the computer programs are run, steps in the first aspect or any possible implementation of the first aspect are performed.

For descriptions of effects of the data query apparatus, the computer device, and the computer-readable storage medium, refer to the descriptions of the data query method, and details are not described herein again.

It should be understood that the above general description and the following detailed description are merely exemplary and explanatory, rather than limiting the technical solutions of the present disclosure.

The data query method, the computer device, and the storage medium are provided in the embodiment of the present disclosure. Virtual data tables corresponding to physical data tables are generated based on attribute information of the physical data tables; a plurality of target virtual data tables in the virtual data tables are associated to obtain a virtual data wide table; and data query is performed by using the virtual data wide table. Data in the virtual data wide table refer to the virtual data tables, and data in the virtual data tables refer to the physical data tables, the virtual data wide table only stores logical relationships of the data, and does not store actual data, therefore, does not need to occupy additional storage space. The virtual data wide table can collect various data in one data table. Corresponding virtual data tables are generated for the physical data tables, and then the virtual data wide table refers to the virtual data tables, thereby simplifying reference relationship of the virtual data wide table and facilitating maintenance.

In order to make the above effects, features and advantages of the present disclosure more comprehensible, preferred embodiments are described in detail below with reference to the accompanying drawings.

### BRIEF DESCRIPTION OF DRAWINGS

In order to more clearly describe the technical solutions of the embodiments of the present disclosure, the accompanying drawings required to be used in the embodiments will be briefly described below, the drawings are incorporated into and constitute a part of the specification, and these drawings show the embodiments consistent with the present disclosure and together with the specification are used to describe the technical solutions of the present disclosure. It should be understood that the following accompanying drawings only show some embodiments of the present disclosure, and therefore should not be considered as a limitation to the scope, and those of ordinary skill in the art may obtain other related accompanying drawings from these accompanying drawings without creative efforts.

FIG. 1 illustrates a flowchart of a data query method according to some embodiments of the present disclosure.

FIG. 2 illustrates a schematic diagram of a data query path according to some embodiments of the present disclosure.

FIG. 3 illustrates a schematic diagram of a data query system according to some embodiments of the present disclosure.

FIG. 4 illustrates a schematic diagram of a data query apparatus according to some embodiments of the present disclosure.

FIG. 5 illustrates a schematic diagram of a computer device according to some embodiments of the present disclosure.

### DETAILED DESCRIPTION OF THE EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. The components of the embodiments of the present disclosure generally described and illustrated herein could be arranged and designed in a wide variety of different configurations. Therefore, the following detailed description of the embodiments of the present disclosure is not intended to limit the claimed scope of the present disclosure, but merely represents selected embodiments of the present disclosure. All other embodiments obtained by those skilled in the art based on the embodiments of the present disclosure without creative efforts shall fall within the protection scope of the present disclosure.

It is found through research that a database usually stores data in a form of physical data tables. When a data query service is provided, the physical data tables usually come from different data sources, with significantly different data structures, different types of stored data, and a large amount of data, resulting in relatively low efficiency in directly querying data from the physical tables. If various physical data tables are directly integrated into one physical data wide table, a large amount of storage space is required. Since the physical data wide table contains a large amount of data, it is difficult to update the physical data wide table.

Based on the above research, a data query method is provided in the present disclosure, where based on attribute information of physical data tables, virtual data tables corresponding to the physical data tables are generated, then a plurality of target virtual data tables in the virtual data tables are associated to obtain a virtual data wide table, and data query is performed by using the virtual data wide table. Data in the virtual data wide table refer to the virtual data tables, and data in the virtual data tables refer to the physical data tables, the virtual data wide table only stores logical relationships of the data, and does not store actual data, therefore, does not need to occupy additional storage space. The virtual data wide table can collect various data in one data table. Corresponding virtual data tables are generated for the physical data tables, and then the virtual data wide table refers to the virtual data tables, thereby simplifying reference relationship of the virtual data wide table and facilitating maintenance.

The above defects existing in the solutions are all results obtained by the inventor after practice and careful research, and therefore, the discovery process of the above problems and the solutions proposed by the present disclosure for the above problems below should all be contributions to the present disclosure by the inventor in the process of the present disclosure.

It should be noted that similar reference numerals and letters indicate similar items in the following drawings, so once an item is defined in one drawing, it does not need to be further defined and explained in the following drawings.

For ease of understanding embodiments, a data query method disclosed in the embodiments of the present disclosure is first described in detail, and an execution subject of the data query method provided in the embodiments of the present disclosure is generally a computer device having a certain computing capability, and the computer device includes, for example, a terminal device, a server, or another processing device. In some possible implementations, the data query method may be implemented by a processor by invoking computer-readable instructions stored in a memory.

The following describes the data query method provided in the embodiments of the present disclosure by using an example in which the execution subject is a terminal device.

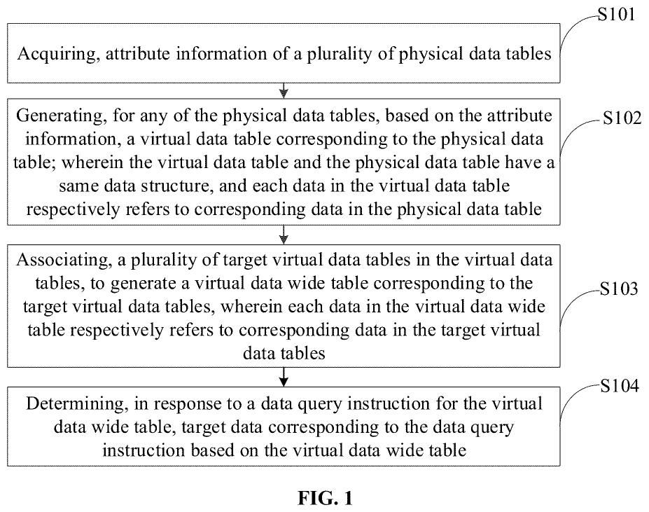

Referring to FIG. 1, which is a flowchart of a data query method according to an embodiment of the present disclosure, the method includes steps S101 to S104.

S101, attribute information of a plurality of physical data tables are acquired.

In this step, the terminal device may acquire the attribute information of a plurality of physical data tables in the database, where the attribute information may include storage locations of the physical data tables, for example, information such as address information, port information, and access protocols of the physical data tables; and the attribute information may further include data structure information of the physical data tables, for example, header information and key value information.

S102, for any one of the physical data tables, based on the attribute information, a virtual data table corresponding to the physical data table is generated; where the virtual data table and the physical data table have a same data structure, and each data in the virtual data table respectively refers to corresponding data in the physical data table.

In this step, the virtual data table corresponding to the physical data table may be generated based on the attribute information of the physical data table, and a schema of the virtual data table may match a schema of the physical data table.

The virtual data table and the physical data table have the same data structure, such as row information, column information and key value information; each data in the virtual data table refers to the corresponding data in the physical data table, respectively. For example, the data in the second row and the third column in the virtual data table may refer to the data in the second row and the third column in the physical data table. When the data in the physical data table are updated, because the data in the virtual data table refer to the data in the physical data table, the data in the virtual data table are also updated.

It should be noted that the data such as key value information in the virtual data table is not actual physical data in the physical data table. The above key value information refers to the data in the physical data table, that is, the virtual data table records a correspondence (the reference relationship) of the key value information between the virtual data table and the physical data table. And the virtual data table does not maintain specific key value data.

The above virtual data table may have a same index structure (for example, a secondary index, a detailed index, a column storage index, or an inverted index) as the physical data table corresponding to thereof.

S103, a plurality of target virtual data tables in the virtual data tables are associated, to generate a virtual data wide table corresponding to the target virtual data tables; where each data in the virtual data wide table respectively refers to corresponding data in the target virtual data tables.

In this step, the virtual data tables may be screened to obtain the target virtual data tables. The target virtual data tables may be screened out according to a query requirement of a query service to be performed.

When screening out the target virtual data tables, an appropriate target screening manner may be selected from a plurality of screening manners. For example, when the user specifies a required virtual data table, the virtual data table specified by the user may be directly used as the target virtual data table; and when the user does not specify any virtual data table, screening may be performed according to a requirement of the target service.

Exemplary, at least one predetermined query statement of a target query service may be firstly acquired, and then a target virtual data table matching the predetermined query statement is determined based on the predetermined query statement.

For example, the target query service may include a plurality of predetermined query statements, and the predetermined query statements may indicate data that need to be queried, so that the virtual data table including the data that need to be queried may be used as the target virtual data table.

The above predetermined query statement may be a query statement of a relational database management system MySQL, that is, a structured query language (SQL), which may be used to access data, query, update, and manage a relational database system, and may be used to perform processing such as operation and conditional query on data in the database by using the query statement.

Further, a model, such as machine learning or deep learning, may also be used to screen the virtual data tables, and may perform analysis and learning by using sample table pattern data provided by the user, historical query statements, and query information collected by the model, to determine the target virtual data tables that better meet the requirement of the user.

After obtaining the target virtual data tables, the target virtual data tables may be associated to generate the virtual data wide table corresponding to the target virtual data tables.

It should be noted that the above target virtual data tables may not only be screened out from the virtual data tables, but also be other virtual data tables specified by the user or the service requirement. For example, in the target virtual data tables, there may be intermediate virtual data tables generated from the virtual data tables, or intermediate virtual data tables generated in other manners and specified by the user.

The above virtual data tables corresponding to the physical data tables may be referred to as near source data tables, and other virtual data tables generated by using the near source data tables may be referred to as service data tables (for example, the intermediate virtual data tables above), where the virtual data wide table above may be one of the service data tables.

In a possible implementation, the near source data tables and/or the service data tables may be used as the above target virtual data tables to generate the above virtual data wide table, and the generated virtual data wide table may also be used to generate other virtual data wide tables.

When the target virtual data tables are associated, a reference data table may be selected from the target virtual data tables firstly, then an association data table is selected from the remaining target virtual data tables, the reference data table is associated with the association data table to obtain a new reference data table, and then the steps of selecting the association data table and updating the reference data table and the association data table may be repeated until the number of the remaining target virtual data tables is zero, and the finally obtained reference data table is used as the above virtual data wide table.

When the reference data table is associated with the association data table, a target association mode may be selected from a plurality of association modes according to the attribute information of the reference data table and the association data table, and then the reference data table is associated with the association data table by using the target association mode to obtain the new reference data table.

Exemplary, the association modes may include Join association, Union association, and Filter association. where:
Join association: Data tables with different Schema are associated by using primary keys and foreign keys of the data tables to obtain a reference data table, and the obtained reference data table may form a continuous data view. Generally, it can be used to associate fact tables and dimension tables, and can present the same schema as a complete and structurally clear physical wide table without generating physical intermediate data.
Union association: A function of splicing partial data into new data may be implemented by associating same fields in different data tables. Data of different calculation modes can be queried under the same Schema without changing calculation logic of the original table, for example, stream data and batch data are spliced, and batch calculation data with different granularities are spliced.
Filter association: A virtual data wide table obtained through the Filter association can be used to solve the requirement of obtaining a convenient and practical small table by means of condition filtering on a large table, and present the same Schema as a small table with clear calculation logic, and does not generate physical intermediate data.

After associating each target virtual data table, a virtual data wide table can be formed. Each field of the virtual data wide table is mapped from the target virtual data tables, and is logically used for a clear Schema. And the virtual data wide table may be queried and used by the user as a normal data table. Meanwhile, the virtual data wide table does not store any table data, but only stores related logic of the tables.

S104, in response to a data query instruction for the virtual data wide table, target data corresponding to the data query instruction are determined based on the virtual data wide table.

After obtaining the virtual data wide table, the user may initiate the data query instruction for the virtual data wide table to the terminal device at any time, where the data query instruction may be the query statement for the virtual data wide table, and the terminal device may parse and execute the data query instruction, and feed the queried target data back to the user to implement the data query.

When querying the target data, a data query path corresponding to the data query instruction may be firstly determined based on the data reference relationship indicated in the virtual data wide table, and then the target query data matching any one of query nodes in the query path are queried from the currently stored intermediate query data. The query nodes indicate data query logic for determining the intermediate query data. In response to any one of the target query data being found, data query may be performed according to the data query path based on the target query data, starting from the query node corresponding to the target query data, to obtain the target data corresponding to the data query instruction.

When the terminal device acquires the data query instruction, because of the layer-by-layer nested structure of the virtual data wide table, the terminal device may parse the data query instruction layer by layer until the data query instruction is parsed into the query statements based on the target virtual data tables. A multi-level data query path may obtain based on the obtained query statements. The data query path may include a plurality of query nodes, and the query nodes may indicate the data query logic for determining the intermediate query data. The intermediate query data corresponding to the query node may be obtained by executing the data query logic.

The above data query logic of the query node usually needs to use the intermediate query data corresponding to the previous query node in the query order. If the intermediate query data corresponding to the current query node can be directly obtained, there is no need to perform queries on the various query nodes before the current query node, which can effectively improve query efficiency.

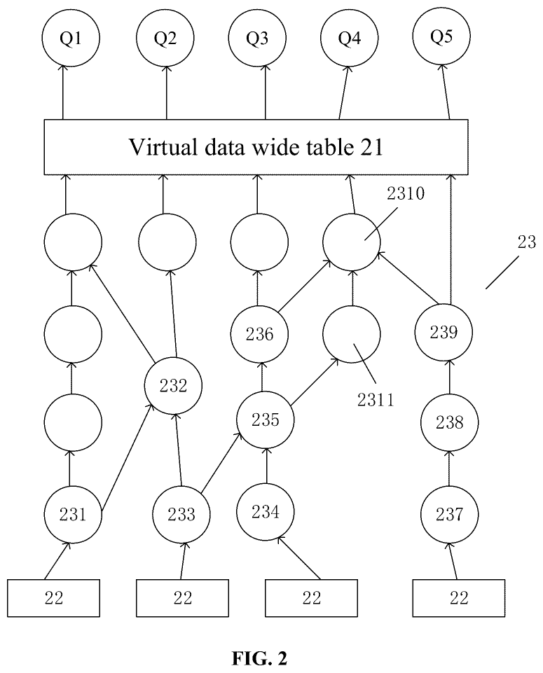

Referring to FIG. 2, which is a schematic diagram of a data query path according to an embodiment of the present disclosure. A plurality of data query instructions (query statements) are included in the figure, which are Q1, Q2, Q3, Q4 and Q5 respectively. The data query paths corresponding to each of the data query instructions are shown in the figure. A virtual data wide table 21, a plurality of physical data tables 22 and a plurality of query nodes 23 are shown in the figure. It can be seen that the query node 231, the query node 232 and the query node 233 serve as a part of the data query paths of Q1 and Q2 simultaneously, that is, a common path of Q1 and Q2. Therefore, the intermediate query data corresponding to the query node 231, the query node 232 and the query node 233 can be calculated and stored in advance, so that when Q1 and Q2 are received, the stored intermediate data can be directly used to realize the quick response of the query statement.

Similarly, in FIG. 2, the query node 234, the query node 235, and the query node 236 are simultaneously located in the data query paths of Q3 and Q4. The intermediate query data of the query node 234, the query node 235, and the query node 236 may be stored. The query node 237, the query node 238, and the query node 239 are simultaneously located in the data query paths of Q4 and Q5. And the intermediate query data of the query node 237, the query node 238, and the query node 239 may also be stored.

Exemplary, in the query path of Q4, if the query node 2310 needs to use the intermediate query data of the query node 236, the query node 239, and the query node 2311 at the same time, the intermediate query data of the query node 2311 may be first determined by using the intermediate query data of the query node 235, and then the intermediate query data of the query node 2310 is determined by using the intermediate query data of the query node 236, the query node 239, and the query node 2311, to obtain the target data corresponding to Q4, thereby greatly improving data query efficiency.

As shown in FIG. 2, in a data query process for Q1, the intermediate query data corresponding to the query node 231 and the query node 232 may be directly acquired, and starting from the query node 231 and the query node 232, the data query is performed according to the data query path by using the intermediate query data.

In a specific implementation process, a predetermined query statement of the target query service may be parsed in advance to determine a common query node (existing in the data query paths of a plurality of query statements), and the intermediate query data corresponding to the common query node are predetermined.

The above pre-stored intermediate query data may be stored in the memory of the terminal device as a cache, and a validity period is set for the pre-stored intermediate query data, thereby reducing the probability that the queried data are inconsistent with the actual result due to the change of the data in the physical data tables.

Since the data of the virtual data wide table come from a plurality of physical data width tables, different types of calculation engines may be used to calculate the split data query logic, and assembly is performed according to the data query path. The user only needs to query the virtual data wide table without perceiving the calculation of the plurality of calculation engines.

When the above intermediate query data are stored in advance, in addition to using the query frequency (the common query node) as a screening condition, screening may also be performed according to complexity of data query logic corresponding to the query node. For example, if a data query logic includes a relatively complex data query logic (for example, summation, counting, an average value, or a variance), the data query logic may be calculated in advance, and the obtained intermediate query data are stored.

The stored intermediate query data may form a materialized view. The position of the corresponding query node in the data query path may be determined through the materialized view, so as to determine whether the intermediate query data are data required by the data query instruction.

In response to none of the target query data being found, the data query may be directly performed according to the data query path, starting from the initial query node in the data query path, to obtain the target data corresponding to the data query instruction.

During data query according to the data query path, some generated intermediate query data may also be stored. For example, for each query node, an importance evaluation value of the query node may be determined based on at least one of a historical query frequency, a calculation complexity, or a predicted query frequency corresponding to the query node, and in response to the importance evaluation value being higher than or equal to a predetermined evaluation value, the intermediate query data corresponding to the query node are stored.

The above intermediate query data may have some association relationships, and the intermediate query data may affect each other. For example, the intermediate query data corresponding to one query node may be determined with the need of the intermediate data of other query nodes, therefore, when determining the importance evaluation value of the query node, the association relationship of the intermediate query data may also be introduced as an evaluation index to determine the importance evaluation value thereof.

During screening of the query nodes, the importance evaluation values of the query nodes may be separately used for evaluation, to screen out query nodes whose importance evaluation values are higher than the predetermined evaluation value. Or a set of query nodes may be screened out from the query nodes, where a sum of importance evaluation values corresponding to the set of query nodes is the highest, so that the optimal combination of the intermediate query data is selected in consideration of relevance of the intermediate query data, thereby improving utilization of the intermediate query data.

The above historical query frequency may be a frequency at which a calculation has been performed for the query node within a predetermined time period. The calculation complexity may be determined according to the operation type and the number of operations in the corresponding data query logic.

The above virtual data wide table may encapsulate the underlying multi-modal physical data, release the user from complex data modelling, perform data modelling in a virtualization manner, and construct a lightweight and flexible data model in a virtual table manner.

The virtual data wide table is a logical structure defined based on the query statements and the association relationships (the reference relationship of the virtual data tables), and is used to organize and indicate the association relationships of data, instead of actually storing data itself. Instead of maintaining an actual copy of the data in the database, the virtual data wide table can be used to acquire the required data by the query statements. The latest data results can be obtained in real time through query and association operations without maintaining and synchronizing a large number of physical data copies, thus saving storage resources and providing a more flexible and dynamic data access manner. The query result of the virtual data wide table can be calculated and analysed in real time according to requirements, to satisfy specific service requirements without worrying about the expansion of data assets and the complexity of storage management.

The virtual data wide table can construct a more flexible and dynamic data model. The logical relationships and the query logic of the data are embedded into the virtual data wide table, to provide higher level data abstraction and organization, so that data processing and analysis are more convenient, and complex query and analysis can be performed through hierarchical relationships and association operations.

In a layer-by-layer nesting process of the virtual data wide table, it may be clearly traced which upstream tables (physical data tables) data in each virtual data table are derived from, forming a data source and a data transmission path. Because the data lineage relationship of the virtual data wide table is clear, the information can be used to sort and merge asset calibers. The asset calibers refer to a definition and standardization of a data asset (the virtual data wide table), including a naming specification, a structure definition, a data type, and the like of data. By analysing the data lineage relationship between the virtual data wide tables, virtual data wide tables with similar data lineage and structure can be identified, and these virtual data tables may correspond to similar service data assets.

When sorting and merging the asset calibers, virtual data wide tables having similar data lineages can be identified and merged by comparing similarity between the virtual data wide tables. High similarity indicates that the data sources and structures of these virtual data wide tables are similar, and may correspond to a same or similar service entity or data view. By merging these similar virtual data wide tables, the work of repeated definition and maintenance can be reduced, and the efficiency and consistency of data management can be improved.

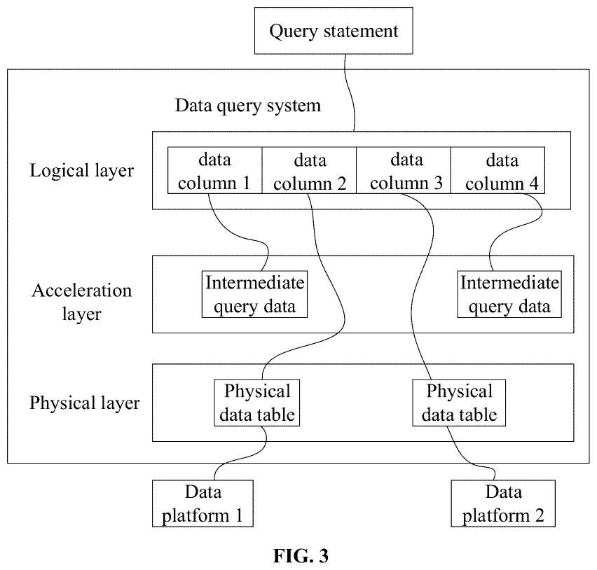

Referring to FIG. 3, which is a schematic diagram of a data query system according to an embodiment of the present disclosure. In FIG. 3, the data query system may include a logical layer, an acceleration layer, and a physical layer. The user may send a query statement for the virtual data wide table to the terminal device of the data query system. Each of data columns in the virtual data wide table are from the physical data tables corresponding to a plurality of virtual data tables. The data of each of the physical data tables may come from different data platforms. The data query system may parse the query statement by the logical layer, search for appropriate intermediate query data in the acceleration layer, search for a part of required data in the physical layer, and return data required by the user based on the intermediate query data and the data found in the physical layer.

Those skilled in the art can understand that in the above method of the specific embodiments, the order of the mentioned steps does not mean a strict execution order or constitute any limitation on the implementation process, and the specific execution order of the steps should be determined by their functions and possible internal logics.

Based on the same concept, a data query apparatus corresponding to the data query method is further provided in an embodiment of the present disclosure. The principle of the apparatus in the embodiment of the present disclosure for solving the problem is similar to that of the above data query method in the embodiment of the present disclosure, reference may be made to the implementation of the method for the implementation of the apparatus, which will not be repeated here.

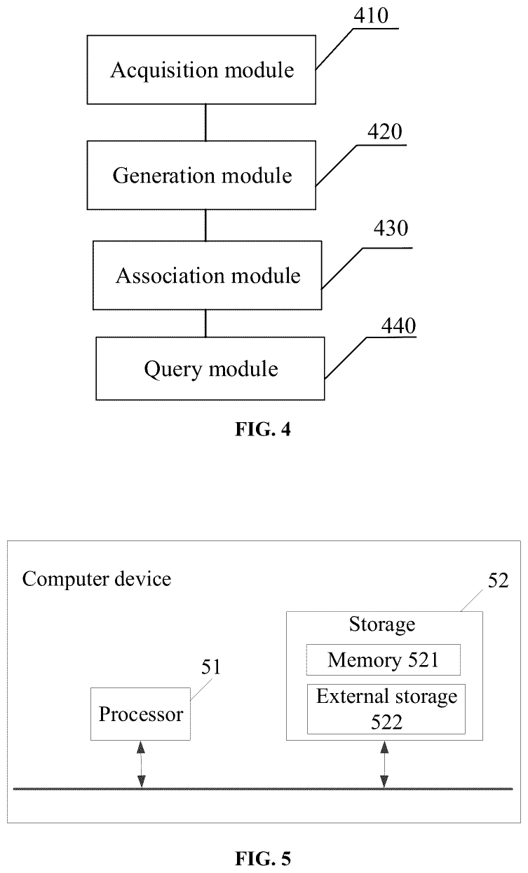

Referring to FIG. 4, which is a schematic diagram of a data query apparatus according to an embodiment of the present disclosure, the apparatus includes:
an acquisition module 410, configured to acquire attribute information of a plurality of physical data tables;
a generation module 420, configured to generate, for any one of the physical data tables, based on the attribute information, a virtual data table corresponding to the physical data table; where the virtual data table and the physical data table have a same data structure, and each data in the virtual data table respectively refers to corresponding data in the physical data table;
an association module 430, configured to associate, a plurality of target virtual data tables in the virtual data tables, to generate a virtual data wide table corresponding to the target virtual data tables, where each data in the virtual data wide table respectively refers to corresponding data in the target virtual data tables; and a query module 440, configured to determine, in response to a data query instruction for the virtual data wide table, target data corresponding to the data query instruction based on the virtual data wide table.

In an alternative implementation, the generation module 420 is specifically configured to:
select, a reference data table from the target virtual data tables;
select, an association data table from remaining target virtual data tables;
associate, the reference data table with the association data table, to obtain a new reference data table; and
repeat, steps of selecting the association data table and associating the reference data table with the association data table, until the number of the remaining target virtual data tables is zero.

In an alternative implementation, when associating the reference data table with the association data table to obtain the new reference data table, the generation module 420 is configured to:
select, based on attribute information of the reference data table and the association data table, a target association mode from a plurality of association modes; and
associate, the reference data table with the association data table by using the target association mode, to obtain the new reference data table.

In an alternative implementation, the apparatus is further includes a determination module configured to:
acquire, at least one predetermined query statement of a target query service; and
determine, based on the predetermined query statement, the target virtual data table matching the predetermined query statement.

In an alternative implementation, the query module 440 is specifically configured to:
determine, in response to the data query instruction for the virtual data wide table, a data query path corresponding to the data query instruction, based on a data reference relationship indicated in the virtual data wide table;
search for target query data matching any one of query nodes in the data query path from currently stored intermediate query data; where the query nodes indicate data query logic for determining the intermediate query data; and
in response to any one of the target query data being found, perform, starting from the query node corresponding to the target query data, data query according to the data query path based on the target query data, to obtain the target data corresponding to the data query instruction.

In an alternative implementation, after searching for the target query data corresponding to any one of the query nodes in the data query path, the query module 440 is further configured to:
in response to none of the target query data being found, perform, starting from an initial query node of the data query path, the data query according to the data query path, to obtain the target data corresponding to the data query instruction.

In an alternative implementation, the query module 440 is further configured to:
in a process of performing the data query according to the data query path, for each of the query nodes, determine, based on a historical query frequency and/or a calculation complexity corresponding to the query node, an importance evaluation value of the query node; and
store, in response to the importance evaluation value being higher than or equal to a predetermined evaluation value, the intermediate query data corresponding to the query node.

For descriptions of the processing procedures of the modules in the apparatus and the interaction procedures between the modules, refer to related descriptions in the foregoing method embodiments, and details are not described herein again.

A computer device is further provided in an embodiment of the present disclosure, as shown in FIG. 5, which is a structural diagram of the computer device provided in an embodiment of the present disclosure, the computer device includes:
a processor 51 and a storage 52, where the storage 52 stores machine-readable instructions executable by the processor 51, the processor 51 is configured to execute the machine-readable instructions stored in the storage 52, and when the machine-readable instructions are executed by the processor 51, the processor 51 performs the following steps:
acquiring, attribute information of a plurality of physical data tables;
generating, for any one of the physical data tables, based on the attribute information, a virtual data table corresponding to the physical data table; where the virtual data table and the physical data table have a same data structure, and each data in the virtual data table respectively refers to corresponding data in the physical data table;
associating, a plurality of target virtual data tables in the virtual data tables, to generate a virtual data wide table corresponding to the target virtual data tables, where each data in the virtual data wide table respectively refers to corresponding data in the target virtual data tables; and
determining, in response to a data query instruction for the virtual data wide table, target data corresponding to the data query instruction based on the virtual data wide table.

In an alternative implementation, in the steps performed by the processor 51, the associating, the plurality of target virtual data tables in the virtual data tables, to generate the virtual data wide table corresponding to the target virtual data tables includes:
selecting, a reference data table from the target virtual data tables;
selecting, an association data table from remaining target virtual data tables;
associating, the reference data table with the association data table, to obtain a new reference data table; and
repeating, steps of selecting the association data table and associating the reference data table with the association data table, until the number of the remaining target virtual data tables is zero.

In an alternative implementation, in the steps performed by the processor 51, the associating, the reference data table with the association data table, to obtain the new reference data table includes:
selecting, based on attribute information of the reference data table and the association data table, a target association mode from a plurality of association modes; and
associating, the reference data table with the association data table by using the target association mode, to obtain the new reference data table.

In an alternative implementation, the steps performed by the processor 51 further include:
acquiring, at least one predetermined query statement of a target query service; and
determining, based on the predetermined query statement, the target virtual data table matching the predetermined query statement.

In an alternative implementation, in the steps performed by the processor 51, the determining, in response to the data query instruction for the virtual data wide table, target data corresponding to the data query instruction based on the virtual data wide table includes:
determining, in response to the data query instruction for the virtual data wide table, a data query path corresponding to the data query instruction, based on a data reference relationship indicated in the virtual data wide table;
searching for target query data matching any one of query nodes in the data query path from currently stored intermediate query data; where the query nodes indicate data query logic for determining the intermediate query data; and
in response to any one of the target query data being found, performing, starting from the query node corresponding to the target query data, data query according to the data query path based on the target query data, to obtain the target data corresponding to the data query instruction.

In an alternative implementation, after searching for the target query data corresponding to any one of the query nodes in the data query path, the steps performed by the processor 51 further include:
in response to none of the target query data being found, performing, starting from an initial query node of the data query path, the data query according to the data query path, to obtain the target data corresponding to the data query instruction.

In an alternative implementation, the steps performed by the processor 51 further include:
in a process of performing the data query according to the data query path, for each of the query nodes, determining, based on a historical query frequency and/or a calculation complexity corresponding to the query node, an importance evaluation value of the query node; and
storing, in response to the importance evaluation value being higher than or equal to a predetermined evaluation value, the intermediate query data corresponding to the query node.

The storage 52 includes a memory 521 and an external storage 522. The memory 521 herein is also referred to as an internal memory, and is configured to temporarily store operation data in the processors 51 and data exchanged with the external storage 522 such as a hard disk. The processors 51 exchanges data with the external storage 522 by using the memory 521.

For a specific execution process of the foregoing instructions, reference may be made to the steps of the data query method in the embodiments of the present disclosure, and details are not described herein again.

A computer-readable storage medium is further provided in an embodiment of the present disclosure, the computer-readable storage medium stores computer programs, and when the computer programs are run by a processor, the steps of the data query method in the foregoing method embodiments are performed. The storage medium may be a volatile or non-volatile computer-readable storage medium.

A computer program product is further provided in an embodiment of the present disclosure, the computer program product carries program codes, and instructions included in the program codes may be used to perform the steps of the data query method described in the above method embodiments, which may refer to the above method embodiments for details, and will not be repeated here.

The computer program product may be specifically implemented by hardware, software, or a combination thereof. In an alternative embodiment, the computer program product is specifically embodied as a computer storage medium, and in another alternative embodiment, the computer program product is specifically embodied as a software product, such as a software development kit (SDK).

It may be clearly understood by a person skilled in the art that, for the purpose of convenient and brief description, a detailed working process of the foregoing system and apparatus may refer to a corresponding process in the foregoing method embodiments, and details are not described herein again. In the several embodiments provided in the present disclosure, it should be understood that the disclosed system, apparatus, and method may be implemented in other manners. The apparatus embodiments described above are merely illustrative, for example, the division of the units is merely a logical function division, and there may be other division manners in actual implementation, for example, a plurality of units or components may be combined or integrated into another system, or some features may be ignored or not performed. In addition, the displayed or discussed mutual coupling or direct coupling or communication connection may be indirect coupling or communication connection through some communication interfaces, devices or units, and may be electrical, mechanical or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions in the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a non-volatile computer-readable storage medium executable by a processor. Based on such understanding, the technical solutions of the present disclosure essentially, or the part of the technical solutions that contributes to the prior art, or the part of the technical solutions, may be embodied in the form of a software product, and the computer software product is stored in a storage medium, including several instructions for causing a computer device (which may be a personal computer, a server, or a network device, etc.) to perform all or part of the steps of the methods described in the various embodiments of the present disclosure. The foregoing storage medium includes: medium that can store program code, such as a USB flash disk, a removable hard disk, a read-only memory (ROM), a random access memory (RAM), a magnetic disk, or an optical disc.

Finally, it should be noted that the above embodiments are only specific embodiments of the present disclosure to illustrate the technical solutions of the present disclosure and not to limit the present disclosure and the protection scope of the present disclosure is not limited thereto. Although the present disclosure has been described in detail with reference to the foregoing embodiments, those of ordinary skill in the art should understand that: within the technical scope disclosed by the present disclosure, any person skilled in the art can still modify or easily conceive changes to the technical solutions described in the foregoing embodiments, or make equivalent substitutions to some of the technical features. These modifications, changes, or substitutions do not make the essence of the corresponding technical solutions depart from the spirit and scope of the technical solutions of the embodiments of the present disclosure, and should be covered within the protection scope of the present disclosure. Therefore, the protection scope of the present disclosure shall be subject to the protection scope of the claims.

What is claimed is:

1. A data query method, comprising:
acquiring attribute information of a plurality of physical data tables;
generating, for any one of the physical data tables, based on the attribute information, a virtual data table corresponding to the physical data table; wherein the virtual data table and the physical data table have a same data structure, and each data in the virtual data table respectively refers to corresponding data in the physical data table;
associating a plurality of target virtual data tables in the virtual data tables to generate a virtual data wide table corresponding to the target virtual data tables, wherein each data in the virtual data wide table respectively refers to corresponding data in the target virtual data tables; and
determining, in response to a data query instruction for the virtual data wide table, target data corresponding to the data query instruction based on the virtual data wide table.

2. The data query method according to claim 1, wherein the associating the plurality of target virtual data tables in the virtual data tables to generate the virtual data wide table corresponding to the target virtual data tables comprises:
selecting a reference data table from the target virtual data tables;
selecting an association data table from remaining target virtual data tables;
associating the reference data table with the association data table to obtain a new reference data table; and
repeating steps of selecting the association data table and associating the reference data table with the association data table until a number of the remaining target virtual data tables is zero.

3. The data query method according to claim 2, wherein the associating the reference data table with the association data table to obtain the new reference data table comprises:
selecting, based on attribute information of the reference data table and the association data table, a target association mode from a plurality of association modes; and
associating the reference data table with the association data table by using the target association mode to obtain the new reference data table.

4. The data query method according to claim 1, wherein the target virtual data tables are screened out from the virtual data tables by:
acquiring at least one predetermined query statement of a target query service; and
determining, based on the at least one predetermined query statement, the target virtual data table matching the at least one predetermined query statement.

5. The data query method according to claim 1, wherein the determining, in response to the data query instruction for the virtual data wide table, the target data corresponding to the data query instruction based on the virtual data wide table comprises:
determining, in response to the data query instruction for the virtual data wide table, a data query path corresponding to the data query instruction, based on a data reference relationship indicated in the virtual data wide table;
searching for target query data matching any one of query nodes in the data query path from currently stored intermediate query data; wherein the query nodes indicate data query logic for determining the intermediate query data; and
in response to any one of the target query data being found, performing, starting from the query node corresponding to the target query data, data query according to the data query path based on the target query data, to obtain the target data corresponding to the data query instruction.

6. The data query method according to claim 5, wherein after searching for the target query data corresponding to any one of the query nodes in the data query path, the data query method further comprises:
in response to none of the target query data being found, performing, starting from an initial query node of the data query path, the data query according to the data query path, to obtain the target data corresponding to the data query instruction.

7. The data query method according to claim 5, further comprising:
in a process of performing the data query according to the data query path, for each of the query nodes, determining, based on at least one of a predicted query frequency, a historical query frequency and a calculation complexity corresponding to the query node, an importance evaluation value of the query node; and
storing, in response to the importance evaluation value being higher than or equal to a predetermined evaluation value, the intermediate query data corresponding to the query node.

8. A computer device, comprising: one or more processors and one or more memories, wherein the one or more memories store machine-readable instructions executable by the one or more processors, the one or more processors are configured to execute the machine-readable instructions stored in the one or more memories, and when the machine-readable instructions are executed by the one or more processors, the one or more processors perform a data query method comprising:
acquiring attribute information of a plurality of physical data tables;
generating, for any one of the physical data tables, based on the attribute information, a virtual data table corresponding to the physical data table; wherein the virtual data table and the physical data table have a same data structure, and each data in the virtual data table respectively refers to corresponding data in the physical data table;
associating a plurality of target virtual data tables in the virtual data tables to generate a virtual data wide table corresponding to the target virtual data tables, wherein each data in the virtual data wide table respectively refers to corresponding data in the target virtual data tables; and
determining, in response to a data query instruction for the virtual data wide table, target data corresponding to the data query instruction based on the virtual data wide table.

9. The computer device according to claim 8, wherein the associating the plurality of target virtual data tables in the virtual data tables to generate the virtual data wide table corresponding to the target virtual data tables comprises:
selecting a reference data table from the target virtual data tables;
selecting an association data table from remaining target virtual data tables;
associating the reference data table with the association data table to obtain a new reference data table; and
repeating steps of selecting the association data table and associating the reference data table with the association data table until a number of the remaining target virtual data tables is zero.

10. The computer device according to claim 9, wherein the associating the reference data table with the association data table to obtain the new reference data table comprises:
selecting, based on attribute information of the reference data table and the association data table, a target association mode from a plurality of association modes; and
associating the reference data table with the association data table by using the target association mode to obtain the new reference data table.

11. The computer device according to claim 8, wherein the target virtual data tables are screened out from the virtual data tables by:
acquiring at least one predetermined query statement of a target query service; and
determining, based on the at least one predetermined query statement, the target virtual data table matching the at least one predetermined query statement.

12. The computer device according to claim 8, wherein query the determining, in response to the data query instruction for the virtual data wide table, the target data corresponding to the data query instruction based on the virtual data wide table comprises:
determining, in response to the data query instruction for the virtual data wide table, a data query path corresponding to the data query instruction, based on a data reference relationship indicated in the virtual data wide table;
searching for target query data matching any one of query nodes in the data query path from currently stored intermediate query data; wherein the query nodes indicate data query logic for determining the intermediate query data; and
in response to any one of the target query data being found, performing, starting from the query node corresponding to the target query data, data query according to the data query path based on the target query data, to obtain the target data corresponding to the data query instruction.

13. The computer device according to claim 12, wherein after searching for the target query data corresponding to any one of the query nodes in the data query path, the data query method further comprises:
in response to none of the target query data being found, performing, starting from an initial query node of the data query path, the data query according to the data query path, to obtain the target data corresponding to the data query instruction.

14. The computer device according to claim 12, wherein the data query method further comprises:
in a process of performing the data query according to the data query path, for each of the query nodes, determining, based on at least one of a predicted query frequency, a historical query frequency and a calculation complexity corresponding to the query node, an importance evaluation value of the query node; and
storing, in response to the importance evaluation value being higher than or equal to a predetermined evaluation value, the intermediate query data corresponding to the query node.

15. A non-transitory computer-readable storage medium, wherein the non-transitory computer-readable storage medium stores computer programs, and when the computer programs are run by a computer device, the computer device performs a data query method comprising:
acquiring attribute information of a plurality of physical data tables;
generating, for any one of the physical data tables, based on the attribute information, a virtual data table corresponding to the physical data table; wherein the virtual data table and the physical data table have a same data structure, and each data in the virtual data table respectively refers to corresponding data in the physical data table;
associating a plurality of target virtual data tables in the virtual data tables to generate a virtual data wide table corresponding to the target virtual data tables, wherein each data in the virtual data wide table respectively refers to corresponding data in the target virtual data tables; and
determining, in response to a data query instruction for the virtual data wide table, target data corresponding to the data query instruction based on the virtual data wide table.

16. The data query method according to claim 6, further comprising:
in a process of performing the data query according to the data query path, for each of the query nodes, determining, based on at least one of a predicted query frequency, a historical query frequency and a calculation complexity corresponding to the query node, an importance evaluation value of the query node; and
storing, in response to the importance evaluation value being higher than or equal to a predetermined evaluation value, the intermediate query data corresponding to the query node.

17. The computer device according to claim 13, wherein the data query method further comprises:
in a process of performing the data query according to the data query path, for each of the query nodes, determining, based on at least one of a predicted query frequency, a historical query frequency and a calculation complexity corresponding to the query node, an importance evaluation value of the query node; and
storing, in response to the importance evaluation value being higher than or equal to a predetermined evaluation value, the intermediate query data corresponding to the query node.

18. The non-transitory computer-readable storage medium according to claim 15, wherein the associating the plurality of target virtual data tables in the virtual data tables to generate the virtual data wide table corresponding to the target virtual data tables comprises:
selecting a reference data table from the target virtual data tables;
selecting an association data table from remaining target virtual data tables;
associating the reference data table with the association data table to obtain a new reference data table; and
repeating steps of selecting the association data table and associating the reference data table with the association data table until a number of the remaining target virtual data tables is zero.

19. The non-transitory computer-readable storage medium according to claim 18, wherein the associating the reference data table with the association data table to obtain the new reference data table comprises:
selecting, based on attribute information of the reference data table and the association data table, a target association mode from a plurality of association modes; and
associating the reference data table with the association data table by using the target association mode to obtain the new reference data table.

20. The non-transitory computer-readable storage medium according to claim 15, wherein the target virtual data tables are screened out from the virtual data tables by:
acquiring at least one predetermined query statement of a target query service; and
determining, based on the at least one predetermined query statement, the target virtual data table matching the at least one predetermined query statement.
